(19) United States
(12) Patent Application Publication
(10) Pub. No.: US 2026/0218683 A1
(43) Pub. Date: Jul. 30, 2026

(54) OBSTACLE WARNING SYSTEM

(71) Applicant: VESTAS WIND SYSTEMS A/S, Aarhus N (DK)

(72) Inventors: Daniel Filipe Simoes Malafaia, Aveiro (PT); Pedro Filipe Viseu Dos Santos, Porto (PT); Pedro Miguel Leao Guedes, Astromil (PT)

(73) Assignee: VESTAS WIND SYSTEMS A/S, Aarhus N. (DK)

(21) Appl. No.: 19/141,112

(22) PCT Filed: Dec. 21, 2023
(86) PCT No.: PCT/DK2023/050327

§ 371 Date: Jun. 19, 2025

(30) Foreign Application Priority Data
Dec. 23, 2022 (DK) PA202201211

(51) Int. Cl. F03D 80/10; G01S 7/40; G01S 13/88; G01S 13/93

(52) U.S. Cl. CPC F03D 80/10; G01S 7/40; G01S 13/886; G01S 13/93

(57) ABSTRACT

A method of operating an obstacle warning system (4) for a wind turbine installation (2) comprises: operating a radar system (14) to obtain scan data for an area around the installation (2); analysing the scan data to identify a pair of signals comprising a first signal corresponding to a first location (34) and a second signal corresponding to a second location (32), the first location (34) being spaced from the second location (32); comparing the first signal and the second signal to determine a value indicative of the performance of the radar system (14) for an area including the second location (32); and activating the warning system (4) if the value is below a threshold.

### TECHNICAL FIELD

This invention relates to obstacle warning systems for fixed installations such as wind turbine installations. In particular, the invention relates to systems configured to avoid collisions by activating warning lights or other alerts on detecting nearby aircraft using a radar system, which systems are also referred to as obstacle collision avoidance systems.

### BACKGROUND

To comply with national and international regulations, structures of a certain height that pose a potential obstacle for aircraft may require warning lights for use at night, to alert nearby aircraft to the presence of the structure and thereby reduce the risk of the aircraft colliding with the structure. Such structures may include installations such as wind turbine installations including one or more wind turbines, also referred to as ‘wind power plants’ or ‘wind farms’.

However, permanent night-time illumination contributes to light pollution, which can be problematic in areas requiring a dark night sky, such as those with a nearby population or a nearby observatory. Wind turbine lighting can also be detrimental to local wildlife, which may be attracted to the lights.

Therefore, it is desirable to restrict illumination for warning purposes to instances when an aircraft is nearby and thereby satisfy regulatory requirements while reducing light pollution. For this purpose, it is known for obstacle warning systems to use radar (radio detection and ranging) systems to detect nearby aircraft and to activate warning lights when aircraft enter a regulatory ‘warning zone’ around an installation. Such a warning zone may cover an area around the installation having a radius of four to six kilometres, for example. The warning lights can be deactivated when no aircraft are detected in the warning zone.

However, in some situations, for example due to a malfunction or when adverse weather conditions prevail, the range of a radar signal may reduce. This creates the possibility that the radar system will not detect an aircraft before it enters the warning zone.

It is against this background that the invention has been devised.

### SUMMARY OF THE INVENTION

An aspect of the invention provides a method of operating an obstacle warning system for a wind turbine installation. The method comprises: operating a radar system to obtain scan data for an area around the installation; analysing the scan data to identify a pair of signals comprising a first signal corresponding to a first location and a second signal corresponding to a second location, the first location being spaced from the second location; comparing the first signal and the second signal to determine a value indicative of the performance of the radar system for an area including the second location; and activating the warning system if the value is below a threshold.

Comparing a pair of signals corresponding to known locations and therefore having expected characteristics relative to one another enables changes in the radar system performance to be identified. For example, under ideal conditions there may be a known and expected difference in the power of the first signal and the power of the second signal, in which case a change in this difference in power is indicative of a change in the radar system performance.

If the value indicative of the radar system performance is below the threshold, this may imply that the radar system cannot be relied upon to detect incoming hazards such as aircraft before the hazard enters a warning zone around the installation. By activating the warning system automatically in this situation, an alert is provided to any such hazards that may arise, even though they may not have been detected, thereby reducing the risk of a collision.

The first signal and the second signal relate to respective known geographical locations in the area around the installation, as may be indicated by the respective directions of origin of the first and second signals for example. It is noted that these signals may not actually have originated from the expected corresponding locations, for example if there is a cause of interference or blockage, such as rain or other precipitation, which reflects signals to the radar system before reaching the intended locations. This may be discernible to some extent from the characteristics of the signals, for example if a difference in power of the signals is smaller than usual.

Although the first location is spaced from the second location, typically these locations are close together and at a similar distance from the radar system.

The first location may define a baseline location, in which case the first signal defines a baseline signal. Correspondingly, the second location may define a reference location, in which case the second signal defines a reference signal.

The method may comprise comparing the respective strengths of the signals of the pair.

The value indicative of the radar system performance may represent a signal-to-noise ratio for the pair of signals. In this respect, the first location may be chosen such that the first signal is representative of the noise floor in the vicinity of the second location, while the second location is chosen on the basis that signals from that location have a higher power under normal conditions, for example due to the presence of reflective features at the second location. In this case, comparing the second signal with the first signal enables a signal-to-noise ratio for the pair of signals to be calculated. A reduction in the signal-to-noise ratio for the pair of signals is then indicative of a corresponding reduction in the performance of the radar system, for example because the signals contain increased levels of clutter.

The threshold may define a noise level. For example, if a signal-to-noise ratio is determined for the pair of signals, this ratio may be compared with a threshold signal-to-noise ratio value to assess the performance of the radar system.

The method may comprise identifying and comparing multiple pairs of signals in the scan data, each pair comprising a respective first signal and a respective second signal corresponding to respective first and second locations. Each first signal of the multiple pairs of signals may relate to a different location within the area around the installation.

The method may comprise evaluating the performance of the radar system. Evaluating the performance of the radar system may comprise estimating a range of the radar system, for example, in which case the value indicative of the performance of the radar system may represent an estimated range of the radar system. Alternatively, or in addition, evaluating the performance of the radar system may comprise estimating a loss factor.

Analysing the scan data may comprise comparing the scan data with calibration data.

The above method may be preceded by performing a calibration routine that comprises operating the radar system to obtain calibration scan data for an area around the installation. The calibration scan data includes data relating to the first location and to the second location.

The calibration routine may comprise analysing the calibration scan data to identify a reference feature, the location of the reference feature then defining the second location. The reference feature may be a highly reflective feature, such as a building or a geographical feature for example. Similarly, the calibration routine may comprise analysing the calibration scan data to identify the first location.

During the calibration routine, signals received from the second location may have a higher power than signals received from the first location. In this respect, the calibration routine may comprise identifying the first location and the second location on the basis of the strength of signals received by the radar system from those locations. The strength of the signals may be monitored for a prescribed period to assess the stability of the signals, in which case only locations from which sufficiently steady signals are received may be selected as the first location and/or the second location.

Activating the warning system may comprise operating a warning light, and optionally multiple lights. Operating a light may comprise effecting flashing of the light. Separately from the outcome of the comparison of the value indicative of performance of the radar system with the threshold, the method may comprise activating the warning system if the scan data indicates the presence of an aircraft in the area around the installation.

The warning system may be configured to alert aircraft to the presence of the installation.

Another aspect of the invention provides a method of calibrating an obstacle warning system for a wind turbine installation. The method comprises: operating a radar system to obtain calibration scan data for an area around the installation; and analysing the calibration scan data to identify a pair of signals comprising a first signal corresponding to a first location and a second signal corresponding to a second location, the first location being spaced from, but in close proximity to, the second location. The second signal has a higher power than the first signal. The strength of the first and second signals may be monitored for a prescribed period, in which case the first and second signals may be identified on the basis of the strength of the signals being sufficiently stable. The first signal may be representative of a noise floor at the second location.

Another aspect of the invention provides an obstacle warning system for a wind turbine installation. The system comprises a radar system configured to obtain scan data for an area around the installation, a warning device, and a control system. The control system is configured to: analyse the scan data to identify a pair of signals comprising a first signal corresponding to first location and a second signal corresponding to a second location, the first location being spaced from the second location; compare the first signal and the second signal to determine a value indicative of the performance of the radar system for an area including the second location; and activate the warning device if the value is below a threshold.

Another aspect of the invention provides a controller or control system for an obstacle warning system for a wind turbine installation. The control system is configured to: analyse scan data obtained by a radar system to identify a pair of signals comprising a first signal corresponding to first location and a second signal corresponding to a second location, the first location being spaced from the second location; compare the first signal and the second signal to determine a value indicative of the performance of the radar system for an area including the second location; and generate a control signal configured to activate the warning device if the value is below a threshold.

It will be appreciated that preferred and/or optional features of each aspect of the invention may be incorporated alone or in appropriate combination in the other aspects of the invention also.

### BRIEF DESCRIPTION OF THE DRAWINGS

So that it may be more fully understood, the invention will now be described, by way of example only, with reference to the following drawings, in which like features are assigned like reference numerals, and in which:

FIG. 1 is a schematic view of a wind power plant comprising an obstacle warning system according to an embodiment of the invention;

FIG. 2 is a schematic view of a portion of the warning system of FIG. 1;

FIG. 3 is a schematic view of the wind power plant of FIG. 1 in an example operating scenario;

FIG. 4 is a schematic view of the wind power plant of FIG. 1 in another operating scenario;

FIG. 5 is a flowchart showing a method according to an embodiment of the invention for commissioning the warning system of the wind power plant of FIG. 1; and

FIG. 6 is a flowchart depicting a method according to an embodiment of the invention for operating the warning system of FIG. 1.

### DETAILED DESCRIPTION

In general terms, embodiments of the invention provide obstacle warning systems and associated warning methods for fixed installations such as wind turbine installations, which are configured to identify scenarios in which there is the potential for aircraft or other hazards to enter a warning zone defined around the installation undetected. In this respect, such warning systems may be configured to operate in dependence on the quality of signals received by an associated radar system that is used to detect hazards in the vicinity of the installation. The quality of the signals may be assessed relative to a corresponding noise floor level, for example.

In some embodiments, the warning system may be operated in a fail-safe mode if the signals received by the radar system indicate that the performance of the radar system is degraded and below a threshold level, in that the warning system is activated automatically, for example to trigger flashing warning lights that are visible to nearby aircraft, in the event that the radar system cannot reliably determine whether a hazard has entered the warning zone. By activating the warning automatically when the performance of the radar system is found to be degraded, situations in which an aircraft is not alerted to the presence of the installation can be avoided. Conversely, activating the warning automatically only when radar performance is evaluated as degraded minimises any additional contribution to light pollution.

The performance of the radar system may include its present scanning range in all directions around the installation, which therefore defines the area the radar is presently capable of scanning effectively. Degradation of the scanning range can occur due to a range of possible factors. Where degradation is suspected, the warning system may trigger a warning in the event that the scanning range or area is evaluated as insufficient to cover the entire warning zone, such that it is possible for a hazard to have entered the zone undetected.

More generally, embodiments of the invention also allow the performance of a fixed radar system or other scanning system to be evaluated in a passive manner, and to detect performance degradation, without additional hardware requirements.

As set out in more detail below, the quality of the radar signals and degradation in the performance of a radar system may be evaluated by making use of landmarks and other reference features in the area scanned by the system to calibrate the system, so that changes in performance can be detected. For example, signals received from the known position of a landmark, which may be referred to as a ‘reference area’ or ‘signal area’, can be compared with signals from a nearby area representative of the corresponding baseline noise level at the geographical location of the landmark, which may be referred to as a ‘baseline area’ or ‘noise area’. This comparison allows the performance of the radar system for the location of the landmark to be assessed, for example to determine the level of noise in signals received from the corresponding geographical area. An increase in noise is then indicative of a reduction in the scanning range of the system, as set out in more detail later.

Accordingly, the baseline area defines a first location and the location of the landmark defines a second location, such that signals received from the first and second locations can be compared to provide an indication of the performance of the radar system.

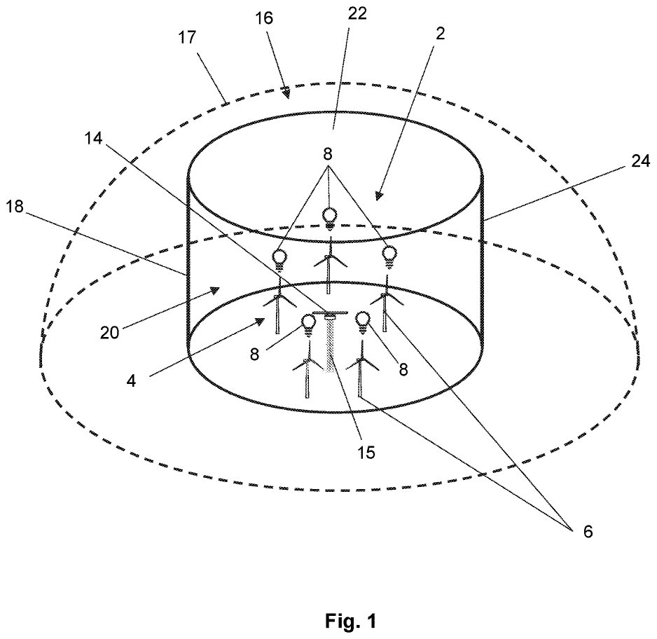

To provide context for the invention, FIG. 1 shows an illustrative onshore wind turbine installation, or ‘wind power plant’ 2, in which an obstacle warning system 4 according to an embodiment of the invention has been implemented. The warning system 4 defines an obstacle collision avoidance system that is configured to reduce the risk of an aircraft colliding with the wind power plant 2. It should be appreciated, however, that obstacle warning systems according to the invention may find application with various other types of fixed installations in a range of locations.

The wind power plant 2 comprises multiple wind turbine generators 6 arranged in a circular array, in this simplified example, the wind turbine generators 6 being typical horizontal axis wind turbines, which are well known in the art and so shall not be described in detail here.

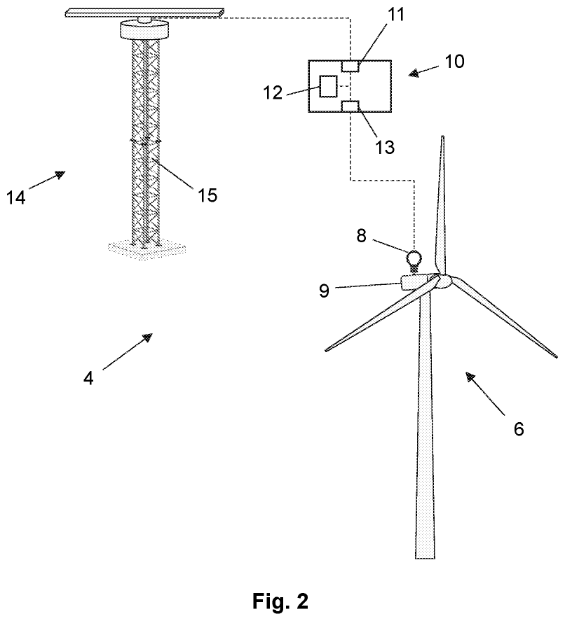

The warning system 4 comprises a set of warning devices in the form of warning lights 8, which act to alert nearby aircraft to the presence of the wind power plant 2 when illuminated. Each warning light 8 is positioned on a respective one of the wind turbine generators 6 in this example. As FIG. 2 shows more clearly, each warning light 8 is mounted to the nacelle 9 of a wind turbine generator 6 in this example. It is also possible for the lights 8 to be supported on other parts of a wind turbine generators, or separately from the wind turbine generators 6, for example on dedicated masts.

The warning system 4 further comprises a control system that is configured to operate the warning lights 8, to illuminate the lights when an aircraft is, or may be, in the vicinity of the wind power plant 2, and thereby alert the aircraft to the presence of the wind power plant 2 to enable the aircraft to take an evasive manoeuvre as may be necessary. Illuminating a light 8 may entail activating flashing of the light 8, for example.

In this example, the control system is embodied as a control unit defining a controller 10 that is shown schematically in FIG. 2, the controller 10 having an input 11 for receiving input data, a processor 12 for analysing the input data and to generate control signals, and an output 13 for issuing the control signals. The control system may be configured in a more distributed configuration involving multiple control units in other arrangements.

The warning system 4 also includes a radar system 14 that is operable to detect incoming aircraft or other hazards and thereby provide the input data required by the controller 10 to operate the warning lights 8. Communication between the controller 10 and the radar system 10, and between the controller 10 and the warning lights 8, is provided for by a suitable network depicted by dashed lines in FIG. 2. For example, the network may be a Modbus network. Accordingly, the input 11 of the controller 10 receives input data in the form of scan data from the radar system 14, that scan data is analysed by the processor 12 to generate suitable control commands, and the controller 10 then issues the control commands through the output 13 to the warning lights 8, to control operation of the warning lights 8.

The radar system 14 is mounted on an upright mast 15, the mast 15 being arranged centrally among the wind turbine generators 6. The radar system 14 has a single radar device in the simplified example shown in FIG. 1, although in other examples the radar system 14 may comprise one or more distributed radar devices, which may be arranged on separate masts or on one or more of the wind turbine generators 6, for example.

The radar system 14 is operable to send and receive signals across an ideal coverage area 16, which represents the maximum possible operating range of the radar system 14 in ideal conditions. The outer bounds of the ideal coverage area 16 may be referred to as the ideal range boundary 17. In the example shown, the mast 15 is positioned with the radar system 14 arranged such that the ideal coverage area 16 is generally hemispherical in shape and centred around the mast 15 and the wind turbine generators 6. It is noted, however, that the ideal coverage area 16 may have a different shape in practice. For example, the radar system 14 may be configured to sweep a full circle in the azimuth plane while scanning an angular range of, for example, 45° in the vertical plane. This leads to an ideal coverage area that is generally toroidal in shape, with a triangular cross-section in the vertical plane and defining a cone of silence above the radar system 14.

A continuous warning boundary 18 is defined around the wind power plant 2, the area bound by the warning boundary 18 defining a warning zone 20. The warning zone 20 represents an area around the wind power plant 2 within which aircraft should be warned of the presence of the wind turbine generators 6, as may be required by local regulations. Accordingly, when an aircraft enters the warning zone 20, the warning lights 8 are illuminated.

In the example shown, the warning zone 20 is substantially cylindrical to define an upright axis that is located centrally with respect to the wind power plant 2. The warning zone 20 extends upwardly from the ground around the wind power plant 2 to define a generally planar boundary ceiling 22 and a generally tubular boundary side 24 in this simplified example. The boundary ceiling 22 may be approximately 300 metres above the ground for example, and the boundary side 24 may have a radius of 4 to 6 km. The warning zone 20 may take various other forms in practice.

The radar system 14 is configured so that the ideal coverage area 16 completely encompasses the warning zone 20, allowing also for a safety margin. That is to say, the radar system 14 has a scanning range that is sufficient to detect an aircraft at any location on the warning boundary 18 when ideal conditions prevail. The controller 10 is configured so that the warning lights 8 are illuminated when the radar system 14 detects an aircraft within the warning zone 20.

However, radar conditions are not always ideal and sub-optimal conditions may cause degradation of the performance of the radar system 14. Such degradation may be caused by adverse weather conditions and/or damage to or a malfunction of the radar system 14, for example, and may manifest as a reduction in the scanning or monitoring range of the radar system 14. In other words, the actual coverage area that is effectively scanned by the radar system 14 may deviate from the ideal coverage area 16 when conditions are not ideal.

To account for the fact that the actual coverage area may be smaller than the ideal coverage area 16, the controller 10 is configured so that the warning lights 8 are illuminated when it is determined that any part of the warning zone 20 extends outside of the actual coverage area of the radar system 14. In this way, a fail-safe mode of operating the warning system 4 is provided which ensures that warning regulations are met, even when the radar system 14 is unable to detect aircraft within the warning zone 20 because of degradation effects.

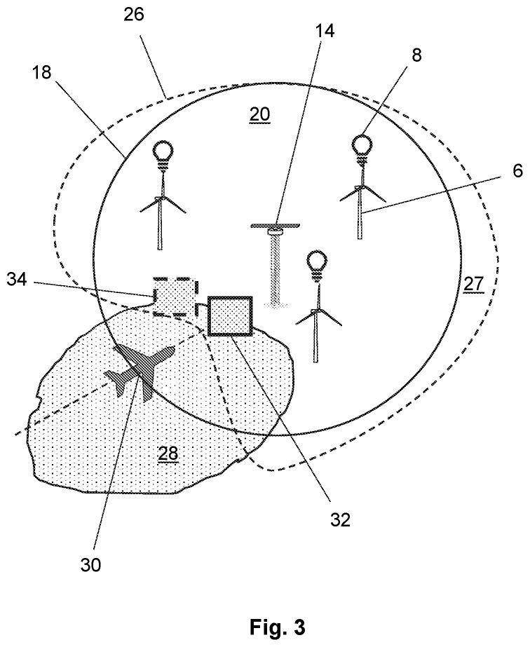

In this respect, FIG. 3 illustrates a scenario in which an aircraft 30 may cross into the warning zone 20 undetected due to degradation in the performance of the radar system 14. FIG. 3 shows the warning boundary 18 as a solid line encircling the wind power plant 2, and a range boundary 26 representing the actual range of the radar system 14 as a dashed line. The area within the range boundary 26 therefore defines the actual coverage area 27 of the radar system 14, also referred to as the ‘scanned area’. In this example, the range boundary 26 extends beyond the warning boundary 18 at most angles with respect to the centre of the warning zone 20, but curves radially inwards to diverge from the ideal coverage area 16 in a lower left portion of the illustration, to cross the warning boundary 18 and extend inside the warning zone 20. This represents a reduction in the range of the radar system 14 in that region.

This range reduction can be caused by a range of factors, including environmental and internal factors, and in this example is due to an area of heavy rainfall 28. The rainfall 28 acts as environmental clutter that interferes with and degrades the radar signals, both by absorbing and thus attenuating the signals and by reflecting the signals back to the radar system 14 before reaching the warning boundary 18 and thus creating clutter in the signals that are received by the radar system 14, which clutter could emulate an expected real reflected signal from features in the ideal coverage area 16 and could therefore be misinterpreted by the radar system 14. So, although the radar system 14 may receive a strong signal from the area of rainfall 28, this signal will be predominantly due to reflection from the rain and not from other features in or beyond the rain.

It is noted that various other conditions may have a similar degrading effect on the performance of the radar system 14, including other types of precipitation such as snow or hail, airborne dust, mist or low cloud cover, changing humidity or temperature. Also, damage to, aging of, or a malfunction of the components of the radar system 14 can contribute to degraded performance, as can a build-up of snow, ice or debris on the components.

Hence, signals emanating from the area of rainfall 28 that are received by the radar system 14 are characterised by high noise, such that features at that location may be indistinguishable from the noise and clutter generated by the rain.

In this respect, the aircraft 30 depicted in FIG. 3 is travelling through the patch of heavy rain 28, such that the rain effectively masks the aircraft 30 from the radar system 14. This is represented by the fact that the aircraft 30 is within the warning zone 20 but outside the range boundary 26 in FIG. 3. Accordingly, the aircraft 30 enters the warning zone 20 undetected.

However, in this example the pilot of the aircraft 30 is nonetheless alerted to the presence of the wind power plant 2 as the warning lights 8 are flashing, having been activated as a precautionary measure when the degraded performance of the radar system 14 was detected, as shall now be explained.

In this respect, the controller 10 makes use of calibration data and landmarks in the scanned area 27 that act as reference features to determine the present performance of the radar system 14 and, in turn, ascertain whether the warning lights 8 should be illuminated as a precautionary measure. One such landmark 32 is shown in FIG. 3, which in this example is a large building that is highly reflective with respect to the signals transmitted and received by the radar system 14, such that the radar system 14 receives a strong, low noise signal back from the location corresponding to the landmark 32 in normal conditions. The location of the landmark 32 therefore defines a reference location, or ‘signal area’, that is used for evaluating the performance of the radar system 14. In turn, signals reflected from the location of the landmark 32 define ‘reference signals’.

A ‘noise area’, ‘baseline location’ or baseline area 34 is defined near to the landmark 32, the baseline area 34 containing no features that are particularly reflective such that signals received by the radar system 14 from this location may be regarded as ‘noise signals’ that are representative of the baseline noise for the radar system 14, or ‘noise floor’, for that geographical region of the scanned area 27. The baseline area 34 is therefore chosen to be as close as possible to the landmark 32, such that it is representative of the baseline level of noise to be expected at the location of the landmark 32. In this respect, the baseline level of noise varies by location and, in particular, tends to increase with distance from the radar system 14.

The baseline area 34 therefore provides a reference by which to determine the quality of signals received from the known location of the landmark 32, and in particular to quantify noise in the landmark signals and to verify the source of the signal. For example, signals received from the baseline area 34 can be used as a reference for determining a power-over-noise level, which may be expressed as a signal-to-noise ratio (SNR), for signals received from the location of the landmark 32. As noted above, although strong signals may be received from the location of the landmark 32, this could be due to clutter caused by rain and not the real, expected reflection from the landmark 32 itself. The ‘noise signal’ received from the corresponding baseline area 34 therefore provides a means by which to assess what is shown in the signal from the landmark location.

More specifically, since the power of the signal received from the baseline area 34 is representative of noise in that region, an SNR for a pair of signals associated with the landmark 32 and the baseline area 34 can be defined as:

$$S N R = \frac{{P}_{r}}{{P}_{n}}$$

In the above, Pᵣ is the signal power for the signal from the location of the landmark, and Pₙ is the signal power for the signal received from the baseline area 34. Although SNR values are determined for pairs of signals, these SNR values are also indicative of the SNR for the signal received from the location of the landmark 32. More generally, the SNR values provide an indication of the performance of the radar system 14 at the geographical region containing the associated pair of locations, namely the landmark 32 and the corresponding baseline area 34.

Notably, using the signals received from the baseline area 34 as a noise reference accounts for changes in the baseline level of noise. Such changes may be widespread, for example caused by changes in humidity or temperature, or may be more local in nature. Referring to the scenario shown in FIG. 3, the patch of rain 28 will increase noise in signals received from both the landmark 32 and the baseline area 34, tending to increase the power of signals received from the baseline area 34 while the power of signals received from the landmark 32, which are expected to be relatively strong in any event due to reflections from the landmark 32, remains relatively unchanged. In this scenario, the SNR calculated for the pair of signals will reduce, so that the reference provided by the baseline area 34 enables the level of noise in the signal from the landmark 32 to be quantified. In effect, this approach allows the controller 10 to verify the source of reflected signals received by the radar system 14, in this example to determine that the radar system 14 is detecting the rain rather than the landmark 32.

Accordingly, the landmark 32 and the baseline area 34 form a location pair, the relationship between whose signals can be used to determine the quality of the signals received from the landmark 32 and, in turn, the performance of the radar system 14.

It is noted that the extent to which the range of the radar system 14 is reduced by the patch of rain 28 is dependent on the intensity of the rain. So, in other scenarios rain may reduce the radar system 14 to a lesser extent, so that the warning zone 20 remains within the scanned area 27. In this situation, typically the warning lights 8 are not activated automatically, as it is expected that any aircraft entering the warning zone 20 will be detected, despite the slight degradation of the radar system performance.

Conversely, it is also possible for signals from the landmark 32 and the baseline area 34 to be entirely blocked by rain or other causes of interference. In this situation, signals received by the radar system 14 from the locations of the landmark 32 and the baseline area 34, or at least from directions corresponding to those locations, will be very similar, since each have reflected from the blockage that generates clutter (for example rain) before ever reaching the intended locations.

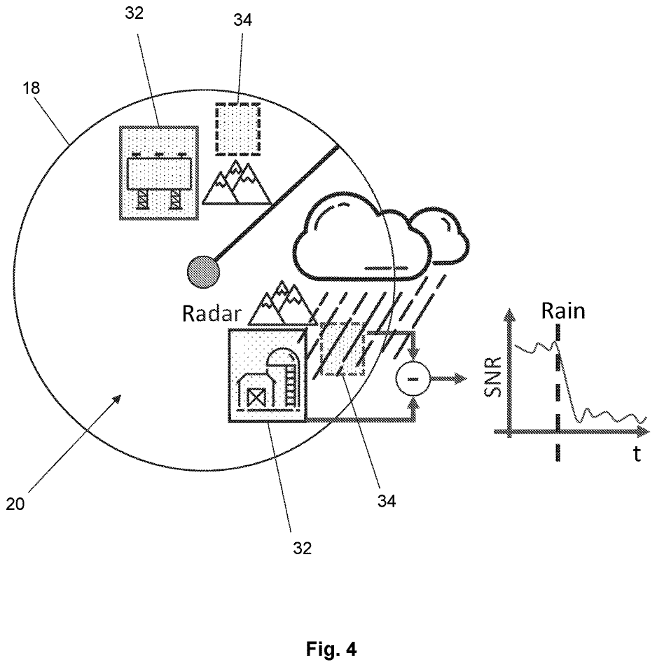

FIG. 4 shows an alternative schematic of the wind power plant 2 to reveal other possible location pairs comprising landmarks 32 and associated baseline areas 34.

Each landmark 32 defines a reference feature that is highly reflective and so can be readily identified by the radar system 14 in ideal conditions. Such features include geographical features such as hills or mountains, and man-made landmarks such as buildings, silos and communication towers, and overhead power lines, for example. In ideal conditions, strong reflection signals are expected to be received from these features, such that the locations of the landmarks 32 represent ‘reference areas’ or ‘signal areas’.

For each location pair, the respective baseline area 34 provides a reference by which to quantify noise in signals received by the radar system 14 from the landmarks 32, or the scanning direction corresponding to the landmarks 32 at least. Each baseline area 34 is located in the vicinity of its respective landmark 32 in this example, and therefore at a similar distance from the radar system 14, to represent the noise floor at that distance. In this respect, and as noted above, each baseline area 34 is chosen on the basis of being indicative of the noise floor for the radar system 14, such that the baseline areas define ‘noise areas’. This may be due to a lack of reflective features in that area, as in the case of an area of flat ground for example. As FIG. 4 shows, a baseline area 34 may be representative of the noise floor due to being hidden behind a geographical or terrain feature such as a mountain that obstructs signals returning from the baseline area.

So, the mountains shown in FIG. 4 could act as landmarks to define reference features, while the spaces immediately behind each mountain serve as a baseline areas 34, these spaces being a good selection for use as baseline areas 34 due to the fact that they will be “shadowed” from the radar signal due to the terrain elevation. However, in the example shown a building is present directly adjacent to each mountain, these buildings being used as the landmarks 32.

Each location pair therefore defines a pair of known locations having corresponding radar scanning directions from which the radar system 14 receives signals in use, those signals having characteristics that can be analysed and compared to evaluate the performance of the radar system 14.

FIG. 4 also shows graphically the effect of rain on the signals received from one of the pairs comprising a landmark 32 and a baseline area 34, in that the SNR of the pair drops sharply when the rain commences. As the SNR reduces, clutter starts to dominate the signals received from landmark 32 and baseline area 34 such that real features within the signals from the landmark 32 become progressively difficult to distinguish with confidence. By extension, when the SNR at the warning boundary 18 falls below a threshold, it would not be possible to detect the aircraft 30 with the required degree of confidence.

It follows from the above that the range of the radar system 14 may be evaluated by comparing the signals received by the radar system 14 for each location pair, to assess the level of noise in the signals received from various regions of the scanned area 27.

Signals corresponding to locations of landmarks 32 exhibiting relatively high noise, and therefore a relatively low SNR for the associated signal pair, are then indicative of degradation in the performance of the radar system 14 in that part of the scanned area 27.

In this respect, under ideal conditions the SNR for a location pair is expected to be high. If the SNR falls, such that the calculated ratio approaches one as the difference in the strength of signals received from the two locations diminishes, this is indicative of degradation in the performance of the radar system 14.

More specifically, the power of reflected signals, Pᵣ, received by the radar system 14 can be related to the distance (R) to the source of the reflection using the following standard equation:

$$R = \sqrt[4]{\frac{{P}_{t} {G}^{2} {λ}^{2} σ}{{( 4 π )}^{3} {P}_{r}}} = \sqrt[4]{\frac{K}{{P}_{r}}} \qquad ( 1 )$$

In the above, most of the variables are constant for a fixed radar system having a constant transmitter power and gain and effective aperture, allowing for the simplified version of the equation on the right in which a constant ‘K’ is introduced to represent those variables. The theoretical maximum range (Rₘₐₓ) of the radar system 14 can then be estimated with reference to reflected signals received having the minimum power detectable by the radar system 14, P_{r_min}, as follows:

$${R}_{max} = \sqrt[4]{\frac{K}{{P}_{r \_ min}}} \qquad ( 2 )$$

This implies that P_{r_min} represents the sensitivity of the radar system 14, which is dependent on the system noise level. A target, detectable reflection signal therefore must be above the noise floor, namely the power of signals received from noisy areas (Pₙ), taking into account the detection threshold, which may be defined as a factor ‘X’ of the noise floor. Hence, the value for P_{r_min} corresponds to the minimum SNR of the radar system 14:

$${P}_{r \_ min} = {P}_{n} * X \text{=>} X = \frac{{P}_{r \_ min}}{{P}_{n}} = {SNR}_{min} \qquad ( 3 )$$

Equation (2) indicates that the received power decays with the fourth order of the distance from the source, namely the radar system 14, to the target. This accounts for the free-space path loss only and does not account for atmospheric attenuation or losses due to errors and uncertainties in the signal processing. To account for these losses, a loss factor (L) may be introduced to represent attenuation of radar pulses and thereby model any type of degradation in the radar system performance due to internal or external effects. The loss factor may be defined as the ratio of the reflected signal power in ideal conditions to the present reflected signal power, which may be expressed as follows:

$$L = \frac{{P}_{r}^{0}}{{P}_{r}} \qquad ( 4 )$$

Using this loss factor, the maximum range in lossy conditions (Rₗₒₛₛ) can be computed as follows:

$${R}_{loss} = \sqrt[4]{\frac{K}{{P}_{r \_ min} L}} \qquad ( 5 )$$

Substituting (2) into (5), and defining an attenuation factor, a, representing the reciprocal of the loss factor, yields a final simplified formula for the actual range of the radar system 14:

$${R}_{loss} = \sqrt[4]{α} \cdot {R}_{max} \qquad ( 6 )$$

The maximum range of the radar system 14 thus decreases proportionally to the fourth root of the fall in the SNR value for a location pair. Meanwhile, it is observed that the SNR for a location pair tends towards one in lossy conditions with high clutter, whereas in low noise conditions the SNR may be generally expressed in terms of the attenuation factor and the measured noise, N_{T}, as follows:

$$SNR = \frac{α {P}_{r}^{0}}{{N}_{T}} \qquad ( 7 )$$

It is noted that the measured noise may be substantially equal to the strength of the signal Pₙ received from the relevant baseline area 34. The above therefore provides a means for estimating the real-time range of the scanning system based on a loss factor, L. It follows that the value of the loss factor can be calculated to correspond to the situation when Rₗₒₛₛ coincides with the range required to reach the warning boundary 18. This value can then be used to set unique thresholds for the SNR of each location pair, for activating the warning system. In this respect, it is noted that the SNR for each location pair is different under ideal conditions, depending primarily on the distance of the location pairs from the radar system 14.

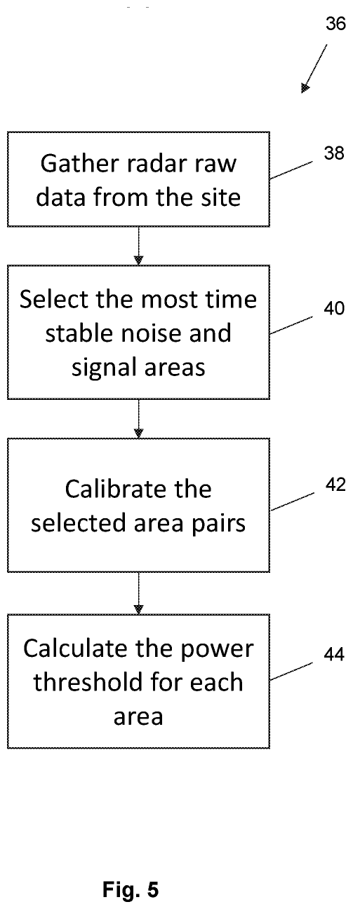

To evaluate the performance of the radar system 14 in this way, the system is first calibrated using a calibration routine 36 shown in FIG. 5. The calibration routine 36 may be performed at commissioning before erecting the wind turbines 6 for example, to ensure that the warning system 4 is functional before the wind turbines 6 are in place. Optionally, the calibration routine 36 may be repeated after commissioning to check for changes in the calibration, for example periodically at regular intervals.

The calibration routine 36 involves operating the radar system 14 to acquire raw data by scanning the ideal coverage area 16 around the wind power plant 2 in ideal conditions (see step 38). In this respect, scanning the area 16 entails transmitting radar signals and then collecting reflections of those signals, otherwise referred to as echo signals. The radar signals may be partly or wholly reflected by reflective mediums located within the ideal coverage area 16. The echo signals are received by the radar system 14 and compiled into scan data, which is communicated to the controller 10. The scan data comprises data indicative of the strength of each echo signal received and the direction of origin of the echo signal, which in turn indicates the location from which the signal emanated under ideal conditions. Accordingly, the location of any reflective medium in the scanned area may be determined from the associated scan data.

The controller 10 is then operated to analyse the scan data to identify echo signals with properties which are stable over a prescribed time period (see step 40), and which therefore indicate fixed, reflective features. Of these stable echo signals, each one that has a strength above a threshold value is identified as having emanated from a respective fixed and highly reflective medium, namely the landmarks 32 defining reference features noted above. In other words, the controller 10 is operated to analyse the scan data to identify the landmarks 32 that will act in future as reference features within the ideal coverage area 16.

Correspondingly, stable echo signals with a strength below a threshold value are determined to be representative of a baseline level of background noise for the associated region of the scanned area, namely the baseline areas 34.

Having identified candidate landmarks 32 and baseline areas 34, the controller 10 then identifies suitable location pairs, namely pairs of landmarks and baseline areas 34 that are within a maximum separation distance from each other, so that the baseline area 34 is representative of the baseline noise at its corresponding landmark 32 to enable a meaningful SNR between the two to be calculated.

Once the location pairs have been defined, the controller 10 calibrates each location pair (see step 42) by determining the SNR relationship for the respective signals of the pair under ideal conditions.

Then, with the SNR for each location pair under ideal conditions calibrated, the controller defines, for each location pair, a respective power threshold (see step 44). More specifically, in this example an SNR threshold is defined for each location pair. The SNR threshold can be calculated, for each location pair, using the loss factor (or attenuation factor) corresponding to the scan range required to reach the warning boundary, for example. Each SNR threshold is calculated such that a fall in the SNR, from that under ideal conditions to a value below the SNR threshold, corresponds to a reduction in the range of the radar system 14 in the direction corresponding to the associated portion of the scanned area 27 to an extent that an aircraft entering the warning zone 20 in that portion could not be reliably detected. Each SNR threshold is calculated to take into account the distance of the location pair from the warning boundary 18.

In other words, each SNR threshold defines a trigger for activating the warning lights 18 in the event that the measured SNR at any location pair falls below the corresponding threshold.

The SNR threshold for each location pair may be adjusted dynamically to account for variation in expected ideal SNRs at different times of day and for different seasons, noting again the impact of ambient conditions including temperature, wind and humidity on the radar signals, even under otherwise ideal conditions.

With the SNR thresholds defined, the calibration routine 36 is then complete and the warning system 4 is ready for operation.

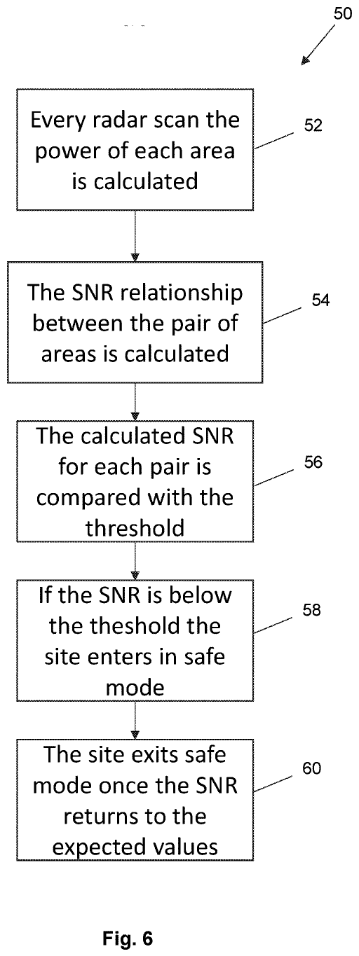

Turning to FIG. 6, a warning process 50 is shown that is performed continuously by the warning system 4 following calibration and commissioning, to implement the calibration to activate the warning lights 8 when degradation is detected in the performance of the radar system 14. In general terms, this involves operating the warning system 4 to compare real-time values for the SNR at each location pair with the corresponding SNR threshold.

Accordingly, the warning process 50 commences by operating the radar system 14 to obtain scan data (see step 52), which entails transmitting and receiving radar signals across the scanned area 27 around the wind power plant 2 in the same way as for the calibration routine 36 as described above, albeit not necessarily under ideal conditions. The controller 10 then analyses the scan data to identify echo signals received from the known locations of the landmarks 32 and the respective paired baseline areas 34, and to calculate the actual SNR for each pair of signals (see step 54).

The controller 10 then compares the actual SNR calculated for each location pair with the corresponding SNR threshold that is defined for the associated location pair (see step 56).

If the actual SNR is below the corresponding SNR threshold at any of the location pairs, then the controller 10 initiates a safe mode in which a precautionary alert is generated. Specifically, the warning lights 8 are activated to flash and therefore provide a warning to any aircraft 30 that may cross into the warning zone 20 undetected (see step 58).

The warning process 50 continues to iterate in the safe mode until the calculated SNR values for the signals at each location pair are all above the respective SNR thresholds.

At this point the warning system 4 exits the safe mode, as the radar system 14 is once again deemed capable of detecting any aircraft that may enter the warning zone 20 at any point on the warning boundary 18 (see step 60).

It follows from the above that the warning process 50 shown in FIG. 6 can be used to activate the warning lights 8 automatically in the operating scenario shown in FIG. 3, in which the operating range of the radar system 14 is reduced by the effect of the area of rainfall 28 in the area of the warning zone 20 that the aircraft 30 is entering undetected. In this way, the warning system 4 provides a warning to the aircraft 30 even without detecting the aircraft 30, while maintaining the ability to deactivate the warning lights 8 at other times to reduce light pollution.

The skilled person will appreciate that modifications may be made to the specific embodiments described above without departing from the inventive concept as defined by the claims.

For example, in some embodiments only a subset of warning lights may be activated on detecting degraded radar performance. In particular, if the analysis of scan data reveals localised degradation in the radar range in a particular direction, only warning lights close to the area of reduced range may be activated.

Also, other thresholds may be defined as an alternative to threshold SNR values for location pairs, for example thresholds for the strength or power of the received signals, or for a difference in strength in the signals of a location pair.

In addition, although embodiments of the invention described above make use of a baseline location representative of the noise floor and a reference location from which much more powerful reflections are received, in principle any pair of locations that are sufficiently close together and from which signals of different strengths are received under ideal conditions may be used to assess the performance of the radar system.

1. A method of operating an obstacle warning system for a wind turbine installation, the method comprising:
operating a radar system to obtain scan data for an area around the installation;
analysing the scan data to identify a pair of signals comprising a first signal corresponding to a first location and a second signal corresponding to a second location, the first location being spaced from the second location;
comparing the first signal and the second signal to determine a value indicative of the performance of the radar system for an area including the second location; and
activating the warning system if the value is below a threshold.

2. The method of claim 1, comprising comparing the respective strengths of the signals of the pair.

3. The method of claim 1, wherein the value represents a signal-to-noise ratio for the pair of signals.

4. The method of claim 1, wherein the threshold defines a noise level.

5. The method of claim 1, comprising identifying and comparing multiple pairs of signals in the scan data, each pair comprising respective first and second signals.

6. The method of claim 5, wherein each first signal relates to a different location within the area around the installation.

7. The method of claim 1, comprising evaluating the performance of the radar system.

8. The method of claim 7, wherein evaluating the performance of the radar system comprises estimating a range of the radar system.

9. The method of claim 7, wherein evaluating the performance of the radar system comprises estimating a loss factor.

10. The method of claim 1, wherein analysing the scan data comprises comparing the scan data with calibration data.

11. The method of claim 1, preceded by performing a calibration routine that comprises operating the radar system to obtain calibration scan data for an area around the installation, wherein the calibration scan data includes data relating to the first location and the second location.

12. The method of claim 11, wherein the calibration routine comprises analysing the calibration scan data to identify a reference feature, and wherein the location of the reference feature defines the second location.

13. The method of claim 11, wherein the calibration routine comprises analysing the calibration scan data to identify the first location.

14. The method of claim 11, wherein signals received from the second location during the calibration routine have a higher power than signals received from the first location.

15. The method of claim 14, comprising identifying the first location and the second location on the basis of the strength of signals received by the radar system from those locations.

16. The method of claim 14, comprising monitoring the strength of the signals for a prescribed period, and identifying the first location and the second location if the strength of each corresponding signal is sufficiently stable.

17. The method of claim 1, wherein activating the warning system comprises operating a warning light.

18. The method of claim 1, comprising activating the warning system if the scan data indicates the presence of an aircraft in the area around the installation.

19. The method of claim 1, wherein the warning system is configured to alert aircraft to the presence of the installation.

20. A method of calibrating an obstacle warning system for a wind turbine installation, the method comprising:
operating a radar system to obtain calibration scan data for an area around the installation; and
analysing the calibration scan data to identify a pair of signals comprising a first signal corresponding to a first location and a second signal corresponding to a second location, the first location being spaced from, but in close proximity to, the second location, wherein the second signal has a higher power than the first signal.

21. An obstacle warning system for a wind turbine installation, the system comprising:
a radar system configured to obtain scan data for an area around the installation;
a warning device; and
a control system configured to:
analyse the scan data to identify a pair of signals comprising a first signal corresponding to a first location and a second signal corresponding to a second location, the first location being spaced from the second location;
compare the first signal and the second signal to determine a value indicative of the performance of the radar system for an area including the second location; and
activate the warning device if the value is below a threshold.
